(19) United States
(12) Patent Application Publication
(10) Pub. No.: US 2018/0013630 A1
(43) Pub. Date: Jan. 11, 2018

(54) METHOD FOR A SWITCH-INITIATED SDN CONTROLLER DISCOVERY AND ESTABLISHMENT OF AN IN-BAND CONTROL NETWORK

(71) Applicant: ARGELA YAZILIM VE BILISIM TEKNOLOJILERI SAN. VE TIC. A.S., Istanbul (TR)

(72) Inventors: SINAN TATLICIOGLU, ISTANBUL (TR); ERHAN LOKMAN, ISTANBUL (TR); SEYHAN CIVANLAR, ISTANBUL (TR); BURAK GORKEMLI, ISTANBUL (TR); METIN BALCI, ISTANBUL (TR); BULENT KAYTAZ, ISTANBUL (TR)

(21) Appl. No.: 15/207,486

(22) Filed: Jul. 11, 2016

(51) Int. Cl. H04L 12/24; H04L 12/46; H04W 8/00; H04L 12/18; H04L 29/12; H04L 12/947; H04L 12/44; H04L 29/08; H04W 84/18

(52) U.S. Cl. CPC H04L 41/12; H04L 12/44; H04L 12/4641; H04W 8/005; H04L 69/324; H04L 12/18; H04L 61/2007; H04L 49/25; H04L 2012/445; H04W 84/18; H04L 61/6022

(57) ABSTRACT

Controller(s) in a software defined network (SDN) are able to determine a control path towards each network switch by performing a switch-originated discovery and using an in-band control network that is an overlay on the data network. A topology tree is maintained, where each controller being the root of the tree, and where messages from the root to any switch may pass through neighboring switches to reach that switch (and vice-versa). Each switch in the SDN attempts to connect to the controller when it does not have a readily configured control connection towards the controller. Once the controller learns about the presence of a new switch and at least one or more paths to reach that switch through a novel discovery process, it can select, adjust and even optimize the control path's route towards that switch.

### BACKGROUND OF THE INVENTION

### Field of Invention

The present invention relates generally to a system and data communication method in software defined network (SDN) and more specifically it relates to a switch-originated control-channel-discovery process, when all of the switches in the SDN are not directly attached to a controller with a physically separate facility. Therefore, it relates to the grafting of a control connection towards the controller over the data network and establishment of an in-band control tree as an overlay to the data network. It applies to both wired and wireless SDNs, and more specifically to SDN based wireless mesh networks (WMNs).

### Discussion of Related Art

Software defined networking consists of techniques that facilitate the provisioning of network services in a deterministic, dynamic, and scalable manner. SDN currently refers to the approaches of networking in which the control plane is decoupled from the data plane of forwarding functions and assigned to a logically centralized controller, which is the ‘brain’ of the network. The SDN architecture, with its software programmability, provides agile and automated network configuration and traffic management that is vendor neutral and based on open standards. Network operators, exploiting the programmability of the SDN architecture, are able to dynamically adjust the network's flows to meet the changing needs while optimizing the network resource usage.

An OpenFlow [see paper OpenFlow Protocol 1.5, Open Networking Forum (ONF)] based SDN is formed by switches that forward data packets according to the instructions they receive from one or more controllers using the standardized OpenFlow protocol. A controller configures the packet forwarding behavior of switches by setting packet-processing rules in a so-called ‘flow table’. Depending on implementation, rather than having one large ‘flow table’ there may be a pipeline, made up of multiple flow tables. A rule in the flow table is composed of a match criteria and actions. The match criteria are multi-layer traffic classifiers that inspect specific fields in the packet header (source MAC address, destination MAC address, VLAN ID, source IP address, destination IP address, source port, etc.), and identify the set of packets to which the listed actions will be applied. The actions may involve modification of the packet header and/or forwarding through a defined output port or discarding the packet. Each packet stream that matches a criteria is called a ‘flow’. If there are no rules defined for a particular packet stream, the switch receiving the packet stream will either discard it or forward the packets along the control network to the controller requesting instructions on how to forward them.

The controller is the central control point of the network and hence vital in the proper operation of network switches. In a typical SDN, the controller is directly attached to each switch with physically separate facilities forming a star-topological control network in which the controller is at the center and all the switches are at the edges. OpenFlow protocol runs bi-directionally between the controller and each switch on a secure TCP channel. The control network that is physically stand-alone is called ‘out-of band’, and is separated from the data network. However, the control network may also be a secure overlay on the data network (in-band), i.e., sharing the same physical facilities with the data traffic. This more complex control network applies to both wired and wireless networks. In some networks, such as the wireless mesh networks, where links may be highly unreliable, or in networks where the switches span a large stretch of geographical area, it may not be practical to directly attach the controller to every switch with a separate facility as in the out of band control networks. A sparsely direct-connected control network may be more realistic because only a few of the larger switches, such as the gateways, can be directly attached to the controller while all the other switches reach the controller via neighboring switches using in-band connections overlaid on the data network.

The aforementioned sparsely direct-connected topology is particularly applicable to a wireless mesh network (WMN) [see paper RFC2501 entitled, “Mobile Ad Hoc Networking, Routing Protocol Performance Issues and Evaluation Considerations]. Wireless mesh infrastructure is, in effect, a network of routers minus the cabling between nodes. It's built of peer radio devices that don't have to be cabled to a wired port like traditional access points do. Mesh infrastructure carries data over large distances by splitting the distance into a series of short hops. Intermediate nodes not only boost the signal, but cooperatively pass the data from a point A to a point B by making forwarding decisions based on their knowledge of the network, i.e., perform routing. Such architecture may, with careful design, provide high bandwidth, spectral efficiency, and economic advantage over the coverage area.

Wireless mesh networks have a relatively stable topology except for the occasional failure of nodes or addition of new nodes. The path of traffic, being aggregated from a large number of end users, changes infrequently. Practically all the traffic in an infrastructure mesh network is either forwarded to or from a gateway, while in ad hoc networks or client mesh networks the traffic flows between arbitrary pairs of nodes.

Lately, there has been some research studies in prior art implementing SDN based Wireless Mesh Network (WMN) [see paper to Chen et al. entitled, “A study on distributed/centralized scheduling for wireless mesh network,”] which is comprised of many interconnected wireless switches and one or more SDN controllers. However, the work assumes that wireless switches run an Internal Gateway Protocol (IGP) to determine routing, and can concurrently receive OpenFlow instructions from the controller to differently process specific flows. Because the number of switches in a WMN is fairly large, an in-band control network is viable by directly attaching only larger WMN gateways to the controller.

In the SDN architecture, a switch awakening after a series of booting processes needs to connect to the controller in order to receive the necessary forwarding instructions. Even though the IP address and the port number of the controller would be manually configured in the switch memory, if the control network is in-band under a changing topology and the switch is not running an IGP it becomes impossible for the switch to connect to the controller. Thus the need for running an IGP in the paper to Chen et al. entitled, “A study on distributed/centralized scheduling for wireless mesh network,” stems from the need to configure the forwarding of in-band control messages between the controller and switches according to the chosen IGP, and doing so, eliminating the need for an explicit controller discovery. Discovery, in this context, means those switches that are not directly attached to the controller determining a path towards the controller. Running an IGP is considered as a stopgap in case the link towards the controller fails and switches can't receive flow tables. However the actual benefit of SDN is the removal of the complex IGP functions such as OLSR and AODV [see paper RFC 3626 entitled, “Optimized Link State Routing,” and paper RFC 3561 entitled “Ad hoc On-Demand Distance Vector (AODV) Routing”] from the wireless routers so that the new hardware-based SDN switches are much less complex, less expensive and extremely fast. Furthermore, fully relying on a centralized control mechanism allows efficient, creative and robust flow routing capabilities as the wireless network topology is changing.

The out of band control network is rather simple. The controller's layer-2/3 address is configured into each switch at the time of the initial configuration, or more controller addresses can be added at a later time using the network management interface of the switch. Since all the switches are hardwired to the controller, they can immediately start an OpenFlow dialog.

OpenFlow is a simplified protocol that has a simple finite machine model. Almost all the messages in this protocol are asynchronous, meaning they don't require a state to handle. However, the initial connection establishment procedure between the controller and a switch involves some version and capability negotiation, therefore a minimal state handling, which has to be done before any other messages can be exchanged. After the secure TLS [see paper RFC 2246 entitled, “Transport Layer Security”] control connection is established, the switch and the controller exchange the ‘hello’ message as defined by the OpenFlow protocol. After receiving the hello message from the other end, the device determines which OpenFlow version is the negotiated version. If the version negotiation is successful, the state machine of the two ends enters into the next phase, feature discovery.

If the control network is in-band, initially a control network discovery is needed. This process determines the location of a control connection between a switch and the controller (via other switches) to send/receive OpenFlow messages. If the switches are not running an IGP, or each switch is not manually configured for a specific control connection, the switches will not know which port to forward their control packets. Even when the in-band control network is manually configured in each switch, if the data network topology is changing as links and nodes go up and down, as in a WMN, the in-band control network topology changes accordingly. Therefore, there is a need for an automatic control network discovery mechanism not only to setup the initial control network topology but also to rapidly modify the graph according to changes in the data network. This significant problem is not addressed in OpenFlow or in any prior art to our knowledge.

Embodiments of the present invention are an improvement over prior art systems and methods.

### SUMMARY OF THE INVENTION

In one embodiment, the present invention provides a method as implemented in a first switch that is part of a software defined network (SDN), the SDN additionally having at least one controller, a second switch and a third switch, the controller storing an in-band control tree, the first switch neighboring the second and third switches, the method comprising the steps of: (a) sending a multicast discovery message to the neighboring, second and third switches, the first and third switches having no active overlay control channel or direct connection with the controller, the second switch having an active overlay control channel or a direct connection with the controller, the multicast discovery message being discarded by the third switch and the multicast discovery message forwarded by the second switch to the controller, where the controller receiving the forwarded multicast discovery message extracts information about the first switch and grafts a new control channel link in the in-band control tree between the first switch and the neighboring, second switch, with the second switch acting as a transit node for communications between the first switch and the controller; (b) the controller initiating the connection at the physical port of the switch that has a link to the controller or the switch receiving a control-port-set-up message from the controller to initiate communication with the controller; and (c) receiving a control flow table from the controller instructing the first switch on which ports to use to forward control packets between the first switch and the controller via the new control channel link with the second switch acting as the transit node.

In another embodiment, the present invention provides a method as implemented in a controller that is part of a software defined network (SDN), the SDN additionally having a first switch, a second switch and a third switch, the controller storing an in-band control tree, the first switch directly neighboring the second and third switches, the method comprising the steps of: (a) receiving a forwarded multicast discovery message from the first switch, where the first switch sends a multicast discovery message to the neighboring, second and third switches, the first and third switches having no active overlay control channel or direct connection with the controller, the second switch having an active overlay control channel or a direct connection with the controller, and where the multicast discovery message being discarded by the third switch and the multicast discovery message being forwarded by the second switch to the controller; (b) extracting information from the received forwarded multicast discovery message about the first switch and grafting a new control channel link in the in-band control tree between the first switch and the neighboring, second switch, with the second switch acting as a transit node for communications between the first switch and the controller; (c) transmitting a connection setup request or a control-port-set-up message to the first switch to initiate communication with the controller; and (d) transmitting a control flow table to the first switch instructing the first switch on which ports to use to forward control packets between the first switch and the controller via the new control channel link, with the second switch acting as the transit node.

In yet another embodiment, the present invention provides a first switch of a software defined network (SDN), the SDN additionally having a first switch, a second switch and a third switch, the controller storing an in-band control tree, the first switch directly neighboring the second and third switches, the first switch comprising: (a) control discovery subsystem sending a multicast discovery message to the neighboring, second and third switches, the first and third switches having no active overlay control channel or direct connection with the controller, the second switch having an active overlay control channel or a direct connection with the controller, the multicast discovery message being discarded by the third switch and the multicast discovery message forwarded by the second switch to the controller, where the controller receiving the forwarded multicast discovery message extracts information about the first switch and grafts a new control channel link in the in-band control tree between the first switch and the neighboring, second switch, with the second switch acting as a transit node for communications between the first switch and the controller; (b) a control flow table received from the controller instructing the first switch on which ports to use to forward control packets between the first switch and the controller via the new control channel link with the second switch acting as the transit node.

In another embodiment, the present invention provides a controller of a software defined network (SDN), the SDN additionally having a first switch, a second switch and a third switch, the controller storing an in-band control tree, the first switch directly neighboring the second and third switches, the controller comprising: (a) a control discovery subsystem analyzing a multicast discovery message forwarded by the first switch and completing a control network discovery process by opening a dialog with the first switch, where the first switch sends a multicast discovery message to the neighboring, second and third switches, the first and third switches having no active overlay control channel or direct connection with the controller, the second switch having an active overlay control channel or a direct connection with the controller, and where the multicast discovery message being discarded by the third switch and the multicast discovery message being forwarded by the second switch to the controller, the control discovery subsystem extracting information from the received forwarded multicast discovery message about the first switch and grafting a new control channel link in the in-band control tree between the first switch and the neighboring, second switch, with the second switch acting as a transit node for communications between the first switch and the controller, and the control discovery subsystem transmitting a connection set up request or a control-port-set-up message to the first switch to initiate communication with the controller; (b) control network optimizer evaluating the in-band control tree and reconfiguring it based on the new control channel link; (c) control network measurement collector collecting measurements from switches in the SDN to evaluate a quality of existing in-band control channels; and (d) control flow table generator generating a control flow table for each switch on the in-band control tree.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIGS. 1 through 5 illustrate a step-by-step controller discovery process on a simple exemplary network.

FIG. 6 illustrates a two-controller network with overlay control channels distinguished by the use of different VLAN IDs.

FIG. 7 illustrates a high-level block diagram of the switch.

FIG. 8 illustrates a high-level block diagram of the controller.

FIG. 9 illustrates a simple flow chart of the discovery process.

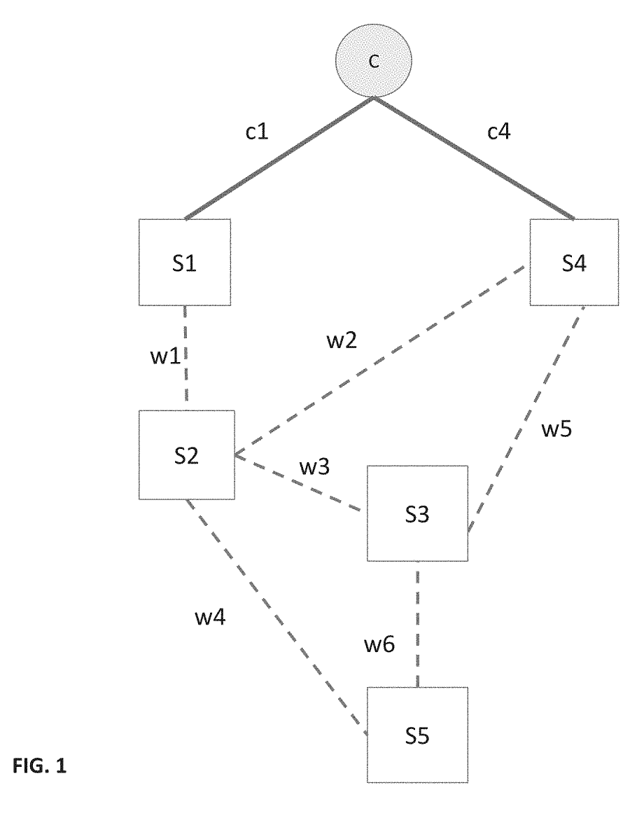

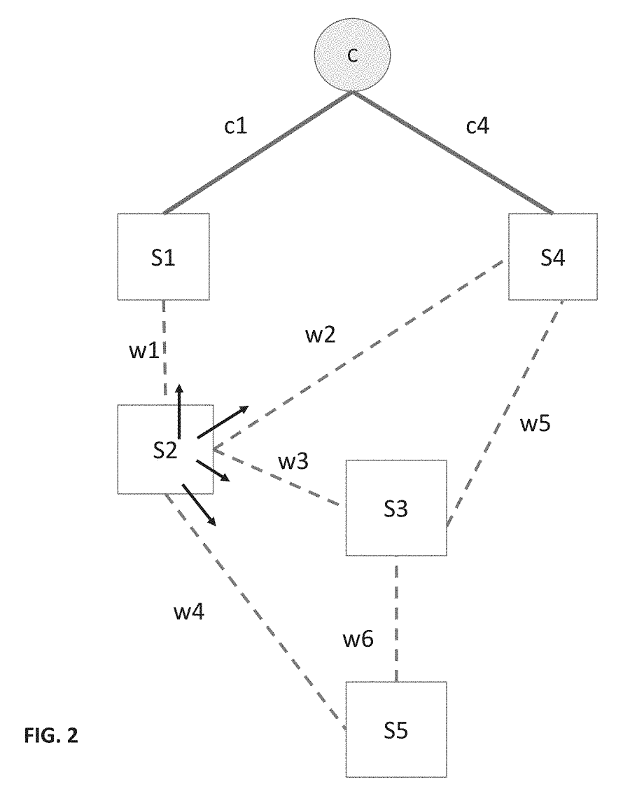

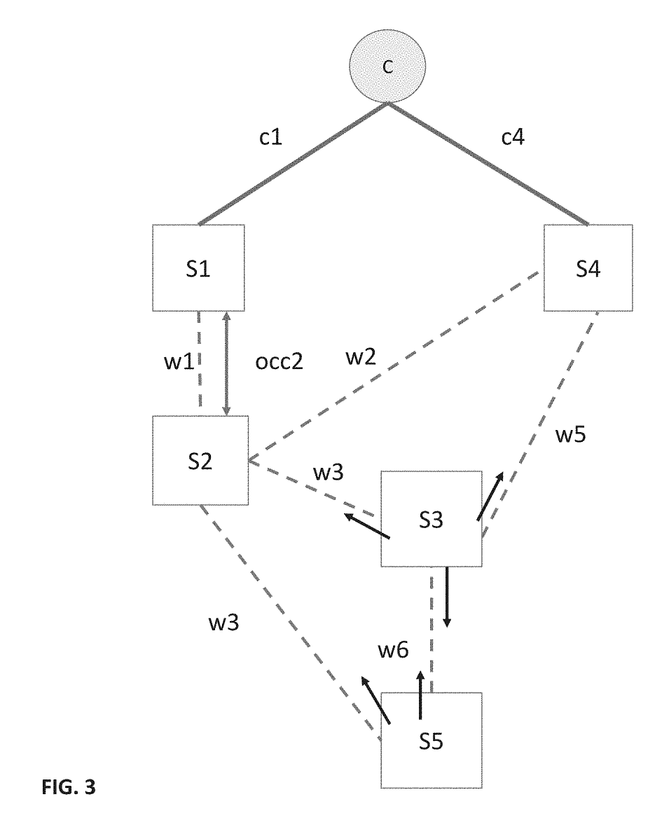

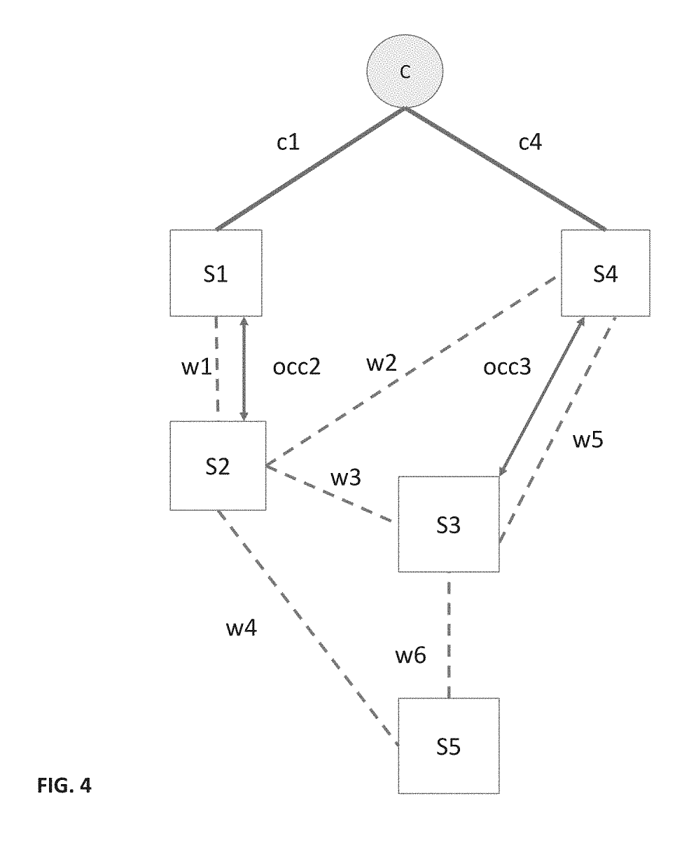

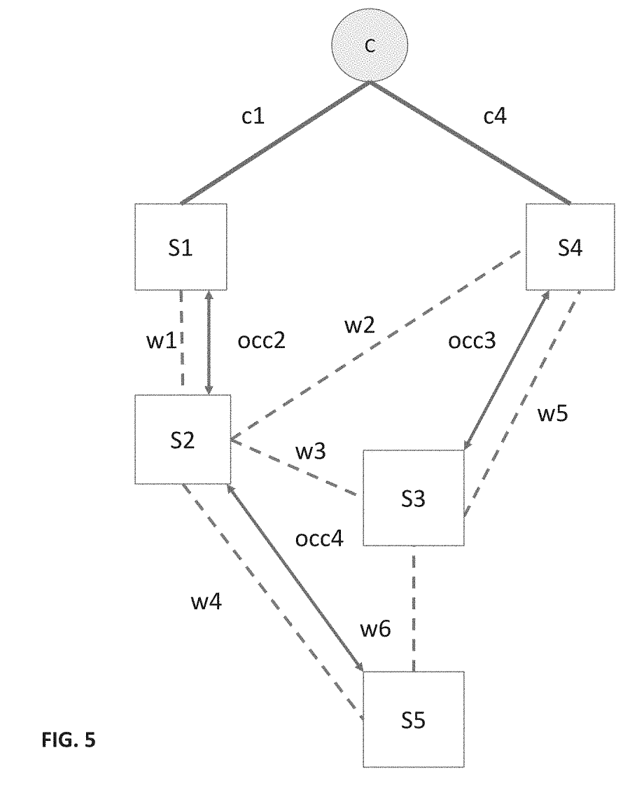

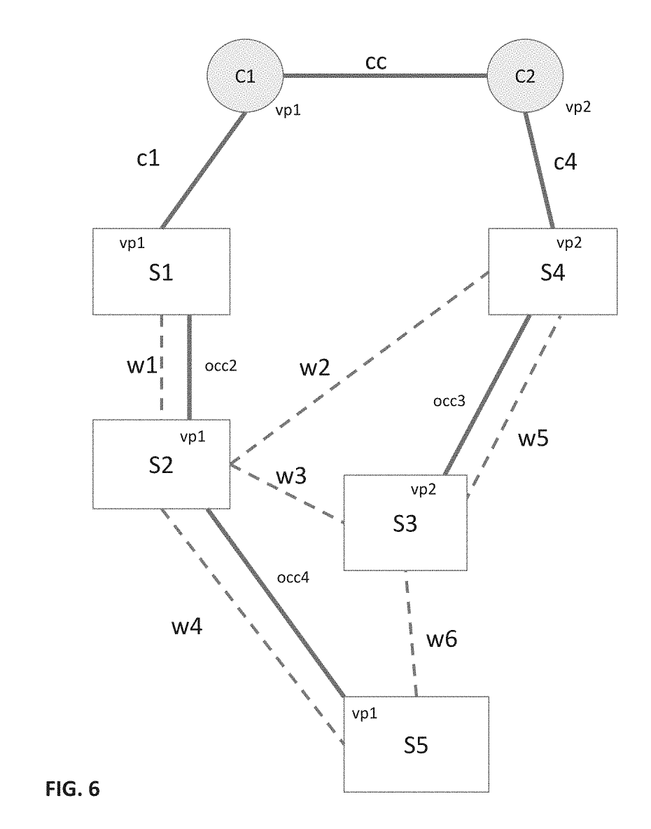

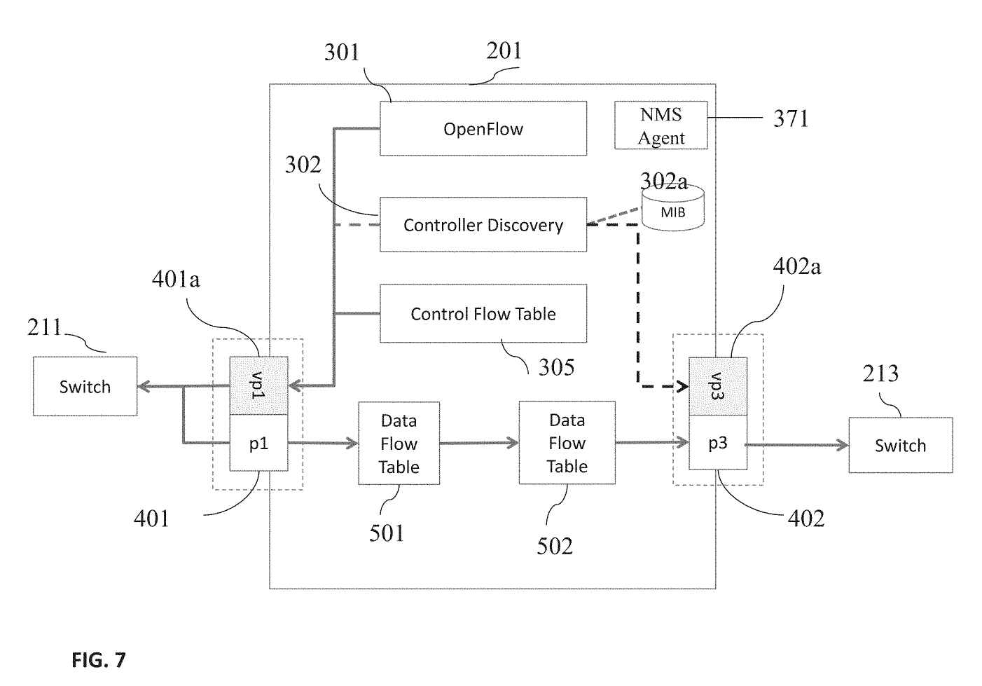

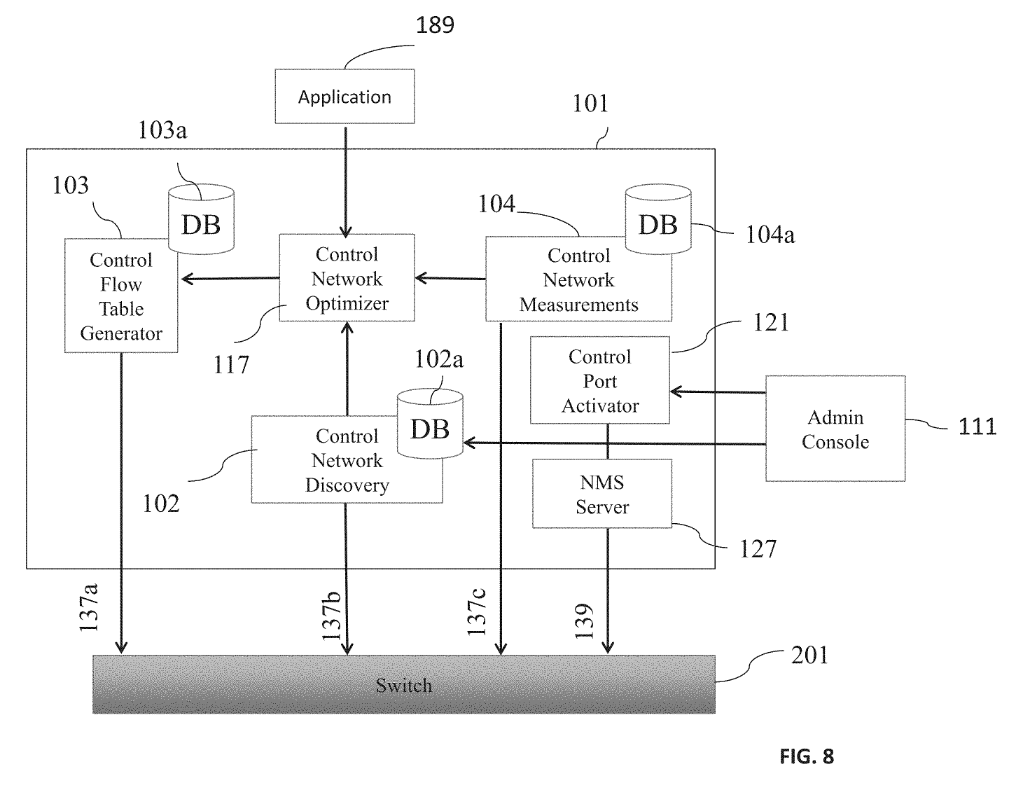

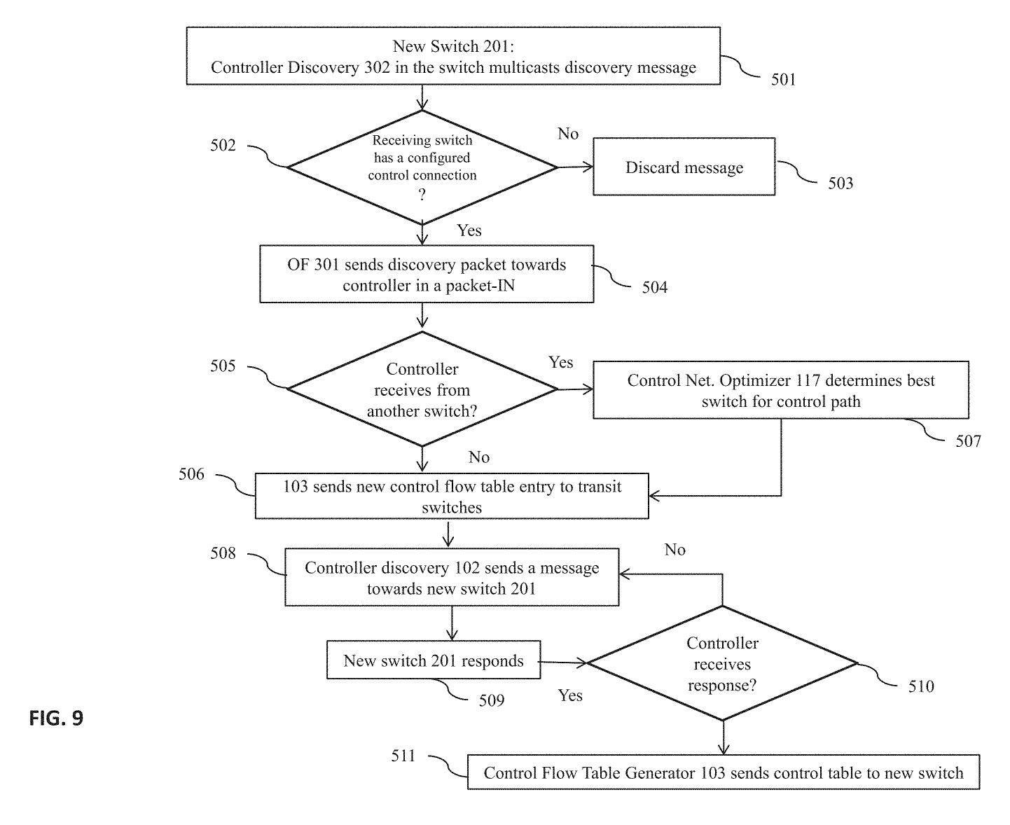

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

An electronic device (e.g., a network switch or controller) stores and transmits (internally and/or with other electronic devices over a network) code (composed of software instructions) and data using machine-readable media, such as non-transitory machine-readable media (e.g., machine-readable storage media such as magnetic disks; optical disks; read only memory; flash memory devices; phase change memory) and transitory machine-readable transmission media (e.g., electrical, optical, acoustical or other form of propagated signals-such as carrier waves, infrared signals). In addition, such electronic devices include hardware, such as a set of one or more processors coupled to one or more other components—e.g., one or more non-transitory machine-readable storage media (to store code and/or data) and network connections (to transmit code and/or data using propagating signals), as well as user input/output devices (e.g., a keyboard, a touchscreen, and/or a display) in some cases. The coupling of the set of processors and other components is typically through one or more interconnects within the electronic devices (e.g., busses and possibly bridges). Thus, a non-transitory machine-readable medium of a given electronic device typically stores instructions for execution on one or more processors of that electronic device. One or more parts of an embodiment of the invention may be implemented using different combinations of software, firmware, and/or hardware.

As used herein, a network device such as a switch, or a controller is a piece of networking equipment, including hardware and software that communicatively interconnects other equipment on the network (e.g., other network devices, end systems). Switches provide multiple layer networking functions (e.g., routing, bridging, VLAN (virtual LAN) switching, Layer 2 switching, Quality of Service, and/or subscriber management), and/or provide support for traffic coming from multiple application services (e.g., data, voice, and video). A network device is generally identified by its media access (MAC) address, Internet protocol (IP) address/subnet, network sockets/ports, and/or upper OSI layer identifiers.

Note while the illustrated examples in the specification discuss mainly an SDN system, embodiments of the invention may be implemented in non-SDN system. It can be implemented in any layered network architecture such as a Network Function Virtualization (NFV) architecture wherein there is control infrastructure separated from data handling. Unless specified otherwise, the embodiments of the invention apply to any controller of the layered network architecture, i.e., they are NOT limited to an SDN controller.

The method and system of this invention allows the controller(s) to determine a control path towards each network switch wherein, a novel switch-originated discovery is performed. The present invention considers an in-band control network that is an overlay on the data network. It is topologically tree forming, wherein each controller is the root of the tree, and messages from the root to any switch pass through neighboring switches to reach that switch (and vice-versa).

According to this invention, each switch in the SDN attempts to connect to the controller when it does not have a readily configured control connection towards the controller. Once the controller learns about the presence of a new switch and at least one or more paths to reach that switch through aforementioned discovery process, it can select, adjust and even optimize the control path's route towards that switch.

Components of the Control Network:

As a general concept, we assume that the control network of an SDN is comprised of
(1) one or more controllers that are reliably and securely interconnected to share control information. These controllers may be in a master-slave configuration, or operate as peers in a load sharing setup. The interconnection between controllers is out of the scope of this invention.
(2) secure, direct and out-of-band control connections to a set of the switches, and
(3) secure, indirect, and in-band (overlay) control connections to the rest of the switches.

A switch's indirect control connection to the controller is comprised of a concatenation of a direct connection and one or more overlay control channels (OCCs), each channel configured on the facility that carries data traffic.

One of the key requirements for the overlay control network is that it must be securely isolated from the data traffic on the same facility. Furthermore, when there are several controllers, the control connections emanating from each switch towards different controllers must be distinguishable.

SDN advocates the concept of a ‘flow’, which is nothing but a stream of packets that are treated in a certain way specified by the controller in each switch. Therefore, we can plausibly treat the in-band control network just like any flow (call it a ‘control flow’) for which match criteria and rules are defined. The packets in this flow are OpenFlow messages either transiting through or terminating at a switch. However, given the control flow must be highly secure and therefore must be treated in an isolation from the data traffic, we alternatively propose to model it as a control VLAN [see paper entitled, “Virtual LAN (VLAN)”] on the SDN data network. Electing this approach though does not rule out a ‘flow’ based modeling for the control channel, since the same general concept of discovery applies to both.

Using a Control VLAN:

According to the present invention, a control VLAN is proposed as a controller-specific overlay network between a controller and all switches. When there are multiple controllers, a separate VLAN per controller is formed. Each VLAN connection is a secure channel defined by OpenFlow (e.g., using TCP/TLS [see paper RFC2246 entitled, “Transport Layer Security”]). The forwarding of control packets between the controller and the switches is, therefore, performed at layer-2, i.e., no layer-3 routing is needed. Although one may argue that the Ternary Content Addressable Memory (TCAM) implementation in SDN switches makes the layer-2 and layer-3 packet processing almost identical in performance, a TCAM can only hold a handful of flows (few thousand in current implementations), wherein rest of the flows unfortunately are processed in software. When TCAM is used for layer-2 flows only, however, its flow processing capacity is more than tenfold increased according to the literature [see paper to Kannen et al. entitled, “Compact TCAM: Flow Entry Compaction in TCAM for Power Aware SDN”]. Therefore, using the layer-2 routing for control network presents such an advantage.

In order to differentiate the control VLANs of different controllers, we can make each control VLAN a ‘tagged’ VLAN with an associated VLAN ID (VID). If there is only one controller and therefore there is only one control VLAN, then tagging may not be essential. However, if the SDN supports other untagged data VLANs in addition to the control VLAN, then tagging can be used as a mechanism to differentiate the control VLAN traffic from all other VLANs. The in-band control network discovery problem we posed earlier becomes the problem of network switches discovering the controller of each control VLAN as the data network topology is changing.

Tagged VLAN:

To support tagged VLANs, a simple 4-byte tag is inserted into the header of a VLAN Ethernet packet. Standards define it as 2 bytes of Tag Protocol Identifier (TPID) and 2 bytes of Tag Control Information (TCI): TPID is the tag protocol identifier, which indicates that a tag header is following and contains the user priority, canonical format indicator (CFI), and the VLAN ID. User priority is a 3-bit field that allows priority information to be encoded in the frame. Eight levels of priority are allowed, where zero is the lowest priority and seven is the highest priority. The CFI is a 1-bit indicator that is always set to zero for Ethernet switches. The 12-bit VID field is the identifier of the VLAN. Actually, it is the only VID field that is really needed for distributing VLANs across many switches.

Control Flow Table:

The switches are simple packet forwarding devices whose sole function is fast packet relaying according to the set of rules provided by the controller. When no rules are provided, the switch does not know where to forward packets. So, configuring ports with VLAN IDs or IP numbers is not sufficient to make the switch function as a layer-2/3 forwarding device. It needs the matching criteria and rules to determine where and how to the forward packets. The prior art defines flow tables only for data packets (or flows) because the forwarding path of control packets between a controller and switch is physically separated when they are hardwired. However, in an in-band control tree, wherein there are other transit switches along the path between the controller and a switch, the controller has to instruct each switch (i) how to forward control packets upward towards the controller, and (ii) how to forward control packets downward towards the switch recipient of the control message. The ‘control flow table’ concept is essentially the forwarding rules associated only with the control traffic, by which a clear distinction is made to ‘data flow table(s)’ that define how user packets are forwarded.

Switch-Originated Controller Discovery Process:

According to the invention, each switch that has neither a direct connection to the controller, nor an IGP to look up for it, yet initiates the discovery of a path towards the controller. In turn, the controller determines the overlay control channel that enables the switch to have an end-to-end control path towards the controller.

According to the proposed method of this patent, when a new switch becomes alive, it starts broadcasting a controller-discovery-packet, similar to a Link Layer Discovery Protocol (LLDP) packet [see paper entitled, “Link Layer Discovery Protocol (LLDP)”], from all of its active ports. The discovery message is sent to a bridged special multicast address that will be reserved for the “controller discovery process” with a time-to-live (TTL) value “1” and therefore it will be received by all directly connected neighbors, but will never get forwarded any further. OpenFlow normally uses the controller-originated LLDP messages to discover the data network connection topology. We decided to distinguish the controller discovery packet from an LLDP packet because their treatments at the switch and the controller side are different.

The source MAC address of the controller-discovery-packet is that of the new switch and the destination MAC address is a specific multicast address, just as in LLDP. The discovery message has all the necessary port MAC layer information, IP number and port information about the new switch. The treatment of the discovery message according to an aspect of this invention is as follows:
If a switch which is one hop away from the newly awakened switch and is receiving the discovery message, has no active overlay control channels or direct connection to the controller, it simply discards the received message, because it doesn't have an established control path towards the controller yet.
If a switch receiving a discovery message from the newly awakened switch has a readily configured overlay control channel towards the controller, i.e., the switch is a potential control transit node, or has a direct connection to the controller, it forwards the received discovery message (after encapsulating it within a packet-In header) along its overlay control channel towards the controller, but does not multicast it to any other switches to which it has a connection. The receiving switch can perform this action on the packet, because it has already received a control flow table from the controller instructing to forward any discovery message towards the controller. The receiving switch generates a packet-IN message according to OpenFlow protocol to encapsulate and send the discovery message to the controller on the overlay control network (i.e., using the control VLAN's tag). The transit switch does not discard the discovery message until a response arrives from the controller. Note that along the physical path between the new switch and the controller, there may be several alternative transit control nodes/switches, each having already configured with an overlay control channel towards the controller. In this scenario, the same discovery message (originated from the new switch) may reach the controller from multiple control paths on the control tree. Since the controller can obtain information about the quality of network links, it can select the best path for the new OCC (or if such a data is not available, the controller can select a control path based on the number of hops or just responds to the first incoming discovery message.). Note that the controller can later collect measurement statistics on the control links and decide to reshape the control tree. Updating the control network topology is out of the scope of the invention.
When the controller receives at least one discovery message in a packet-IN message sent by the transit node (which has a control path towards the controller), the controller will attempt to graft a control channel between the transit switch and the new switch to the existing control tree, simply by initiating the connection at the physical port of the switch that has a link to the controller or sending a “control-port-set-up” message. Meanwhile, it will send a control flow table entry to each transit switch on the control path towards the new switch so that they can forward messages between the controller and the new switch to appropriate control ports. This message will be targeted to the source MAC address of the new switch (which is in the discovery message forwarded to the controller by the transit switch) and traverse along the configured control path towards the transit node attached to the new switch, and therefrom to the source MAC address—noting that the last transit node that generated the packet-IN reported the port it arrived to the controller.
The new switch will respond to the connection set up request of the controller or the “control-port-set-up” message with a “hello” message towards the controller thus initiates the normal OpenFlow messaging protocol. The rest of the dialog between the switch and the controller is performed according to OpenFlow. Please note that the discovery messaging described here only discovers paths from the switches to the controller and not the entire data network topology, and therefore complete data flow tables can't be sent by the controller to the switches yet. However, the controller can build the entire network topology in time and incrementally update data flow tables to a completion.
If none of the neighboring switches receiving the multicast message has an active overlay control channel, the message gets dropped by the neighbors, and then the new switch waits for a preconfigured time interval and repeats broadcasting the discovery messaging until it receives a connection set up request or a “control-port-set-up” message from the controller as described above. Once the switch receives a connection set up request or a “control-port-set-up” message, it stops sending the discovery message. Accordingly, there is a simple state management with the discovery process. If/when the switch notices that the current controller is not reachable anymore, it restarts the discovery process.
When the controller receives the discovery message from the new switch, it discovers the following:
   Information about the new switch, e.g., port MAC addresses;
   If the new switch is directly attached to the controller or not;
   The overlay control channel to use towards the switch. This is the channel between the transit switch that sent the packet-IN message and the new switch.

When the controller discovery process is completed, i.e., all switches in the network have channels toward the controller(s), each switch will also be configured with a control flow table, defining how OpenFlow control packets will be processed. The control flow table also defines how discovery messages of the neighboring switches must be forwarded towards the controller inside packet-IN messages.

Multiple Controllers:

If there are multiple controllers in the network, each controller will have a different overlay control network. Each such control network can be modeled as a tagged VLAN with a different VID. The switch can either send a single controller-discovery-packet to reach any controller its neighbors have connections to, or separately discover control paths towards each controller by initiating the discovery process in the VLAN of that controller. For example, if the switches are configured for two controllers, using VID=1 for controller-1 and VID=2 for controller-2 control networks, then the switch generates two discovery messages, one with VID=1 and one with VID=2. Each receiving transit switch treats the message in that specific VLAN separately. Doing so, the topologies of control VLAN-1 and control VLAN-2 may come out different.

Consider a simple exemplary network illustrated in Error! Reference source not found. There is a single controller, C, and five switches, S1, S2, S3, S4 and S5, wherein the controller is directly attached to only switches S1 and S4, with connections c1 and c4, respectively. Switches S2, S3 and S5 are attached to the controller with in-band control channels, i.e. do not have direct connections. Note that switch S1 is the transit switch for S2, switches S1 and S2 are transit switches for S5, and switch S4 is the transit switch for S3.

When the switches S1 and S4 awaken they will easily discover the controller since they have direct physical connections to the controller. When S1 and S4 are registered in the control network of C, C will program them to forward any controller discovery messages inside packet-IN messages.

Since S2 doesn't have a physical connection to C it needs to broadcast the controller-discovery-packets from its active ports. The switches S1, S3, S4 and S5 will all receive the controller-discovery-packets sent by S2 as shown in Error! Reference source not found. S3 and S5 will simply discard them since they themselves do not have any control path defined yet. However since S1 and S4 are programmed to forward controller-discovery packets they will send them to C inside packet-IN messages. C will receive two controller-discovery messages from the same sender S2 through S1 and S4, separately. C will choose one of them as the control path (in our example occ2+c1 will be the control path as shown in Error! Reference source not found) and send a control-port-set-up message back. When S2 gets a connection set up request from the controller or a control-port-set-up message, it will stop broadcasting and send OpenFlow “hello” message from the port it received the connection request or the control-port-set-up message.

S3 will similarly connect to C through S4 (over occ3+c4) as shown in Error! Reference source not found. S5 may have started broadcasting the controller-discovery-messages at the same time with S2 and S3 however, it will not be able to connect to C until S2 or S3 sets up a connection. In our example, S5 will connect to C through S2 and S1 (over occ5+occ2+c1) as shown in Error! Reference source not found.

Although we kept the specific techniques for control network optimization out of scope, it is worthwhile to mention that most controllers will have ways to collect real-time data from switches on the quality of control channels, and compare those with other potential alternatives. These measurements will feed into a control network optimizer in the controller. The controller can initiate a reconfiguration of the control network by sending OpenFlow instructions, if certain poorly performing channels can be switched-over to other better-performing connections.

Error! Reference source not found. shows the previous network with two controllers, C1 and C2. This time S1 has a direct physical connection (c1) to C1 and S4 has a direct physical connection to (c2) C2. S2, S3 and S5 will connect to C1 or C2 (or to both of them) through S1 and S4. If S2 broadcasts controller-discovery-packets without specifying a controller ID it can connect either C1 or C2 since S2 has connections to both S1 and S4. In some scenarios, this would be the ideal case but in other scenarios we may wish S2 to connect to C1, not to C2. In order to satisfy this requirement, we propose the use of VLAN tags to specify the controller IDs.

In Error! Reference source not found. two control VLANs are formed, with VID=vp1 for C1 and VID=vp2 for C2. When S1 connects to C1, C1 programs S1 to forward the controller-discovery packets with VID=vp1 to itself and C2 programs S4 similarly for the controller discovery packets with VID=vp2. S2 broadcasts the same controller-discovery packets but this time with a VLAN tag having VID=vp1. When S4 receives those packets with VID=vp1, it simply discards them because S4 doesn't have connection to C1. S1 receiving the same packets will forward them to C1. However when S3 broadcasts the controller-discovery packets with VID=vp2, this time S1 will discard them while S4 will forward them to C2. In our example, S5 broadcasts the controller-discovery packets with VID=vp1, thus it is connected to C1 through S2 and S1.

Distinguishing the overlay control networks from each other by using different VLAN tags also provides isolation of them from each other thus enhancing the security. However, when VLAN tags are used, each switch needs to make a new broadcast for each controller it needs to connect to, thus increasing the number of broadcasts and complexity. We believe that depending on the implementation scenarios using VLAN tags would be necessary in some cases.

Error! Reference source not found. depicts the high-level block diagram of an SDN switch with the additional functions required for in-band control network discovery. Switch 201 is attached to switches 211 and 213, of which switch 211 is located on the in-band control network while switch 213 is not. Both switches 211 and 213 are attached to switch 201 for data plane traffic. Note that physical port 401 on switch 201 is the connection port to 211, and similarly physical port 402 is the connection port to 213. On these ports, VLAN ports vp1 and vp3 are active. However, because only switch 211 is on the control network, there is a control flow table entry associated with this port only.

There are three key software functions for discovery: Controller discovery 302 is the function that activates discovery messaging process when there are no control flow tables in the switch or when the switch just comes to life. It also manages the state of the discovery process. It has an associated Management Information Base (MIBO 302a), which contains information such as MAC and IP addresses of all ports, and other relevant switch information, that goes into a discovery message. MIB has time to live (TTL) type parameters used in discovery messaging state management. These MIB values can be set by Network Management Server (NMS) agent 371, which is controlled by an NMS server in the controller. NMS may use a protocol such as SNMP [see paper RFC 3413 entitled, “Simple Network Management Protocol (SNMP)”] or other protocols (such as OVSDB or Open-Config). NMS Agent may also collect statistics from the ports of the switch to feed into OpenFlow messages when requested by the controller or activate new VLAN switch ports for newly arrived controllers. Control Flow Table 305 is sent to switch 201 by the controller and contains forwarding instructions for packets in the in-band control network. Data Flow Tables 501 and 502 are cascade flow tables instructing switch 201 what to do with data flows according to prior art. OpenFlow 301 is where messages received from the controller are processed, or messages are generated towards the controller. This is where the initial hello message from the controller and subsequently the control flow tables are received.

Error! Reference source not found. depicts a high-level block diagram of additional functions needed in the controller to support in-band control network discovery. Controller 101 has Control Discovery module 102 that receives the discovery message inside the packet-IN received from a transit switch. It collaborates with Control Network Optimizer 117 to determine the path for an OCC if there are multiple options available. Optimizer 117 has an interface to Control Network Measurements 104, which collects real-time network performance data from the switches. DB 104a contains the raw data as well as the processed data on each link's quality.

Admin console 111 communicates with Control Network Discovery 102 to modify network discovery parameters, or it can initialize connection set up process or control port activation on switches for a new controller.

According to the flow chart illustrated in Error! Reference source not found, Control Flow Table Generator 103 obtains the most recent control network topology and determines the flow tables per switch. This information is stored in DB 103a. Control Flow Table Generator sends the tables to each switch with an OpenFlow message on interface 137a. Interface 137b is where hello message is sent according to OpenFlow to a newly discovered switch. Controller 101 queries network switches for performance measurements using interface 137c, which is also OpenFlow. Any network management commands to the switches are sent on interface 139 from NMS server 127 or optionally using OpenFlow. Application 189 communicates with controller 101 to provide specific network requirements to Control Network Optimizer 117.

A simple flow-chart illustrating the method of this invention is illustrated in Error! Reference source not found. The process starts at step 501 in which the controller discovery 302 of new switch 201 multicasts a discovery message. At step 502, each neighbor switch receiving the message checks to determine if it has a control channel towards the controller. If not, in step 503, the switch discards the message. If the receiving switch has a control path towards the controller, in step 504, it generates a packet-IN message towards the controller with the received discovery message encapsulated inside this message. In step 505, the controller receives the packet-IN and checks to determine if it has received the same discovery message from another switch. If it hasn't, in step 506, it sends a new control flow table to each transit switch along the path between the switch that sent the packet-IN and the controller, to indicate how to forward packets between the new switch and the controller. If the controller received the packet from multiple switches according to step 507, it sends the multiple transit switch options to Optimizer 117 to determine the best path towards the new switch. In step 508, the controller sends a connection set up request or a control-port-set-up message towards the new switch. In step 509, the new switch receives and responds to the message. When the controller receives the response, in step 511, it sends the control flow table entries to the new switch.

Many of the above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

### CONCLUSION

A controller subsystem, a switch subsystem and a method for in-band control network discovery in a Software Defined Network (SDN) using a switch-originated discovery process is described. The method is applicable in SDNs wherein out-of-band (direct) connections from the controller to every switch in the network are not economical or feasible as in radio networks and specifically in wireless mesh networks. The invented discovery process is compliant with the current architecture of SDN. If any control channel on the in-band control network fails, and as a result, one or more switches lose their connection to the controller, the discovery process is re-initiated by the switch. Furthermore, using a software capability in the controller, the in-band control network topology can be re-adjusted and even optimized by analyzing the performance of the links carrying control channels. For multi-controllers SDN scenarios a Virtual LAN (VLAN) per controller with a tree topology wherein the root is a controller and edges are switch-to-switch virtual overlay channels is proposed.

1. A method as implemented in a first switch that is part of a software defined network (SDN), the SDN additionally having at least one controller, a second switch and a third switch, the controller storing an in-band control tree, the first switch directly neighboring the second and third switches, the method comprising the steps of:
a. sending a multicast discovery message to the neighboring, second and third switches, the first and third switches having no active overlay control channel or direct connection with the controller, the second switch having an active overlay control channel or a direct connection with the controller, the multicast discovery message being discarded by the third switch and the multicast discovery message forwarded by the second switch to the controller, where the controller receiving the forwarded multicast discovery message extracts information about the first switch and grafts a new control channel link in the in-band control tree between the first switch and the neighboring, second switch, with the second switch acting as a transit node for communications between the first switch and the controller;
b. the controller initiating the connection at the physical port of the switch that has a link to the controller or the switch receiving a control-port-set-up message from the controller to initiate communication with the controller; and
c. receiving a control flow table from the controller instructing the first switch on which ports to use to forward control packets between the first switch and the controller via the new control channel link with the second switch acting as the transit node.

2. The method of claim 1, wherein the in-band control tree is a virtual LAN (VLAN).

3. The method of claim 2, wherein the VLAN is a tagged port based VLAN.

4. The method of claim 2, wherein VLAN is different for each controller serving the SDN.

5. The method of claim 1, wherein the in-band control tree is a packet flow carrying control traffic.

6. The method of claim 1, wherein the multicast discovery message is a Link Layer Discovery Packet (LLDP).

7. The method of claim 1, wherein the multicast discovery message contains at least the MAC address of the first switch.

8. The method of claim 1, wherein the multicast discovery message contains IP addresses that belong to the first switch.

9. The method of claim 1, wherein the multicast discovery message is encapsulated in an OpenFlow packet-IN message.

10. A method as implemented in a controller that is part of a software defined network (SDN), the SDN additionally having a first switch, a second switch and a third switch, the controller storing an in-band control tree, the first switch directly neighboring the second and third switches, the method comprising the steps of:
a. receiving a forwarded multicast discovery message from the first switch, where the first switch sends a multicast discovery message to the neighboring, second and third switches, the first and third switches having no active overlay control channel or direct connection with the controller, the second switch having an active overlay control channel or a direct connection with the controller, and where the multicast discovery message being discarded by the third switch and the multicast discovery message being forwarded by the second switch to the controller;
b. extracting information from the received forwarded multicast discovery message about the first switch and grafting a new control channel link in the in-band control tree between the first switch and the neighboring, second switch, with the second switch acting as a transit node for communications between the first switch and the controller;
c. transmitting a connection set up request or a control-port-set-up message to the first switch to initiate communication with the controller; and
d. transmitting a control flow table to the first switch instructing the first switch on which ports to use to forward control packets between the first switch and the controller via the new control channel link, with the second switch acting as the transit node.

11. The method of claim 10, wherein the in-band control tree is a virtual LAN (VLAN).

12. The method of claim 11, wherein the VLAN is a tagged port based VLAN.

13. The method of claim 1, wherein VLAN is different for each controller serving the SDN.

14. The method of claim 10, wherein the in-band control tree is a packet flow carrying control traffic.

15. The method of claim 10, wherein the multicast discovery message is a Link Layer Discovery Packet (LLDP).

16. The method of claim 10, wherein the multicast discovery message contains at least the MAC address of the first switch.

17. The method of claim 10, wherein the multicast discovery message contains IP addresses that belong to the first switch.

18. The method of claim 10, wherein the multicast discovery message is encapsulated in an OpenFlow packet-IN message.

19. A first switch of a software defined network (SDN), the SDN additionally having a first switch, a second switch and a third switch, the controller storing an in-band control tree, the first switch directly neighboring the second and third switches, the first switch comprising:
a. control discovery subsystem sending a multicast discovery message to the neighboring, second and third switches, the first and third switches having no active overlay control channel or direct connection with the controller, the second switch having an active overlay control channel or a direct connection with the controller, the multicast discovery message being discarded by the third switch and the multicast discovery message forwarded by the second switch to the controller, where the controller receiving the forwarded multicast discovery message extracts information about the first switch and grafts a new control channel link in the in-band control tree between the first switch and the neighboring, second switch, with the second switch acting as a transit node for communications between the first switch and the controller;
b. a control flow table received from the controller instructing the first switch on which ports to use to forward control packets between the first switch and the controller via the new control channel link with the second switch acting as the transit node.

20. A controller of a software defined network (SDN), the SDN additionally having a first switch, a second switch and a third switch, the controller storing an in-band control tree, the first switch directly neighboring the second and third switches, the controller comprising:
a. a control discovery subsystem analyzing a multicast discovery message forwarded by the first switch and completing a control network discovery process by opening a dialog with the first switch, where the first switch sends a multicast discovery message to the neighboring, second and third switches, the first and third switches having no active overlay control channel or direct connection with the controller, the second switch having an active overlay control channel or a direct connection with the controller, and where the multicast discovery message being discarded by the third switch and the multicast discovery message being forwarded by the second switch to the controller, the control discovery subsystem extracting information from the received forwarded multicast discovery message about the first switch and grafting a new control channel link in the in-band control tree between the first switch and the neighboring, second switch, with the second switch acting as a transit node for communications between the first switch and the controller, and the control discovery subsystem initiating the connection at the physical port of the switch that has a link to the controller or transmitting a control-port-set-up message to the first switch to initiate communication with the controller;
b. control network optimizer evaluating the in-band control tree and reconfiguring it based on the new control channel link;
c. control network measurement collector collecting measurements from switches in the SDN to evaluate a quality of existing in-band control channels; and
d. control flow table generator generating a control flow table for each switch on the in-band control tree.
